(19) United States
(12) Patent Application Publication
(10) Pub. No.: US 2017/0089189 A1
(43) Pub. Date: Mar. 30, 2017

(54) ACTIVE TORSIONAL DAMPTER FOR ROTATING SHAFTS

(71) Applicant: LORD Corporation, Cary, NC (US)

(72) Inventors: Mark A. NORRIS, Cary, NC (US); Askari BADRE-ALAM, Cary, NC (US); David EDEAL, Apex, NC (US); Daniel O'NEIL, St. Albans, VT (US); Andrew D. MEYERS, Chapel Hill, NC (US)

(21) Appl. No.: 15/310,996

(22) PCT Filed: Jun. 16, 2015
(86) PCT No.: PCT/US2015/036029

§ 371 Date: Nov. 14, 2016

Related U.S. Application Data
(60) Provisional application No. 62/012,836, filed on Jun. 16, 2014.

(51) Int. Cl. E21B 43/26; F16F 15/18; F04B 49/06; F16F 15/00; F04B 23/00; F04B 11/00

(52) U.S. Cl. CPC E21B 43/26; F04B 23/00; F04B 11/00; F04B 49/065; F16F 15/002; F16F 15/18; E21B 47/00

(57) ABSTRACT

Systems and methods are disclosed herein that include providing an active torsion damper control system that includes a rotatable component (206) and a rotatable measurement interface (302) disposed on the rotatable component, the rotatable measurement interface having at least one torsional strain gauge configured to measure a strain of the rotatable component, a torque management (306) computer configured to determine a resonant frequency of the rotatable component and a corrective torque needed to be applied to the rotatable component to excite the resonant frequency as a function of the measured strain, and a correction motor (308) configured to impart the corrective torque on the rotatable component.

### CROSS-REFERENCE TO RELATED APPLICATION

The instant application claims the benefit of U.S. Provisional Patent Application Ser. No. 62/012,836, filed Jun. 16, 2014, the disclosure of which is incorporated herein by reference in its entirety.

### TECHNICAL FIELD

The subject matter disclosed herein relates generally to the design and operation of rotating shafts mechanically linked to a power plant and/or a transmission. More particularly, the subject matter disclosed herein relates to the control of torsional vibration and the design, operation, monitoring and controlling of the strain and/or torque of a rotating shaft having torsional vibrations.

### BACKGROUND

Torsional vibration is a concern in power transmission systems using drive shafts, rotating shafts or couplings (e.g., automotive and marine drivelines, power-generation turbines, reciprocating pumps and engines). These vibrations lead to catastrophic failures when not controlled properly. Torsional vibrations are angular vibrations of an object—along its axis of rotation. Torsional vibration robs power, reduces efficiency, creates uncomfortable vibration, increases wear, and causes extreme safety hazards around heavy equipment, helicopters, trucks, ships, power equipment and any other system using rotating shafts.

In a non-limiting example, driveshafts are commonly employed for transmitting power from a rotational power source, such as the output shaft of a transmission, to a rotatably driven mechanism, such as a differential assembly and/or gearbox to transmit mechanical power to generate motion, pumping action, or electricity. The torsional loading of the driveshaft is rarely uniform over an extended period of time even at relatively constant engine speeds and as such, the driveshaft is typically subjected to a continually varying torsional load. These variances in the torsional load carried by the driveshaft create torsional vibrations which generate undesirable mechanical and acoustical noise in systems connected with the driveshaft. For example, in a car, truck, bus, helicopter, or ship, the mechanical and acoustical noise associated with the vehicle drivetrain is undesirable to passengers in the vehicle. In other instances, the vibration that is transmitted through the driveshaft generates fatigue in the driveshaft and other drivetrain components, thereby shortening the life of the vehicle drivetrain. This occurs when the variances in load create harmonic excitations that excite the drivetrain torsional resonances. Thus, it is desirable and advantageous to attenuate or cancel these torsional vibrations in the driveshaft.

In power generation, with systems using rotating and translating components, the torques generated are never smooth. Most reciprocating machines are based on a crank mechanism (i.e., a crankshaft) with several elements that cannot be perfectly balanced. As such, the crankshaft is subject to strong dynamic vibrations, including torsional vibrations. The engines, compressors, and/or pumps may excite the torsional resonances due to the fact that they apply dynamic forces on the drivetrain. The components transmitting the torque can generate non-smooth driving torque, heat, and varying loads (e.g., elastic drive belts, worn gears, and misaligned shafts). Because no material is infinitely stiff, these effects result in twisting vibration about the axis of rotation. Additionally, over extended usage, critical components (e.g., transmission shafts, drive shafts, and gearboxes) in the drivetrain can fail due to high cycle fatigue.

Because torsional vibration can be introduced into the drivetrain by a variety of sources, complete mitigation is challenging. Even a drivetrain with a very smooth rotational input can develop torsional vibrations from rotating or imbalanced internal components. A non-limiting list of some common components providing input to the torsional vibration include: internal combustion engines, reciprocating pumps, universal joints, stick slip, and backlash. For internal combustion engine the torsional vibrations are generated by combustion dynamic forces and crankshaft geometry creates torsional vibration in the driveshaft. For reciprocating pumps the pistons generate discontinuous forces on the drivetrain through the crankshaft from the compression cycles. For universal joints the geometry of the universal joint causes torsional vibrations when the driveshaft components are not parallel and/or misaligned. For stick slip, during the engagement of a friction element (e.g., clutch), stick slip creates torsional vibrations. For backlash, lash in a drivetrain cause torsional vibrations when the direction of rotation changes.

As another non-limiting example, torsional vibration is a concern in the crankshafts of internal combustion engines because prolonged or excessive vibrations could break the crankshaft itself; shear-off the flywheel; or cause driven belts, gears, and attached components to fail. This is especially true when the frequency of the excitation matches the torsional resonant frequency of the crankshaft.

Until now, various kinds of damping devices have been used to control torsional vibration of rotating machines and are employed once the amplitude of the torsional vibrations is incompatible with the safe operation of the machine. Devices are typically chosen based on mechanical, thermo-mechanical, and cost characteristics. Often torsional vibration dampers are applied at one end of the crankshaft and are made of a flywheel (or seismic mass), where geometric configurations widely vary. These dampers are connected to the shaft by suitable elastic and damping elements (in automobiles, for example, integration occurs within the front pulley). In many applications there may be only one of these elements, and sometimes the restoring force can be supplied by the centrifugal field due to rotation and the seismic mass may have the shape of a counterbalance of the crankshaft. The two most popular types of torsional dampers are tuned dampers (or harmonic balancers or harmonic dampers) and viscous dampers. The markets for torsional vibration control products include automotive, aerospace/aviation, marine, power harvesting and generation, agriculture, construction, mining, and oil & gas.

Tuned dampers use a spring element and an inertia ring that is typically tuned to the first torsional natural frequency of the crankshaft. This type of damper reduces the vibration at specific engine speed and/or transmission stages when an excitation torque excites the first natural frequency of the crankshaft, but not at other speeds or transmission gear stages. When the engine and/transmission changes speed or gears away from the absorber resonance, the tuned absorber is no longer effective, and the system's torsional vibration will actually increase at other frequencies due to the addition of this device.

The current approach is to attach tuned dampers to shafts, such as crankshafts and/or drive shafts, to attenuate torsional vibrations. This approach has several drawbacks. One such drawback is that these devices are usually tuned to a specific frequency and consequently will only damp vibrations within a relatively narrow frequency band. Accordingly, these devices are employed to effectively damp vibrations at a single critical frequency and offer little or no damping for vibrations that occur at other frequencies. Another drawback with conventional mechanical damping devices relates to their incorporation into an application, such as an automotive vehicle. Generally speaking, these devices tend to have a relatively large mass, rendering their incorporation into a vehicle difficult due to their weight and overall size. Another concern is that it is frequently not possible to mount these devices in the position at which they would be most effective, as the size of the device will often not permit it to be packaged into the vehicle at a particular location.

Viscous dampers consist of an inertia ring in a viscous fluid. The torsional vibration of the crankshaft forces the fluid through narrow passages that dissipate the vibrations as heat. The viscous torsional damper is analogous to the hydraulic shock absorber in an automotive suspension. The viscous damper typically has high inertia and lowers the natural frequency of the drive shaft system, which in itself can be problematic.

The viscous damper, the current alternative to the tuned torsional damper, provides some broad band dampening of torsional vibrations. These devices are used in higher power applications compared to passenger vehicles. Examples for applications for viscous damper are agricultural, heavy duty and marine applications. The viscous damper utilizes a large rotary inertia mass that moves independently in a shear fluid contained within a housing mounted to the crank or drive shaft. The shear fluid, often a silicone, provides viscous damping when the fluid operates in shear. Thus, the oscillatory input amplitudes of the crank are met with a counteracting torque generated through the shear damping effect. Energy is dissipated from torsional vibration into heating of the shear fluid. Though a viscous damper is less effective than a fixed tuned damper at its specifically tuned frequency, the viscous damper is able to counteract torsional vibration across more frequencies than that of a tuned damper.

The viscous damper has additional drawbacks. To operate, highly viscous silicon oils are used as the damping fluids. The shearing of the damping fluid and the concomitant heat generation over the period of use of the damper, leads to wear of the silicon oil especially due to the breaking up of long-chained oil molecules. This changes the damping properties of the damper until, from a certain limit onwards, the damper is not suitable any more to affect adequate damping. This oil wear is irreversible and results in a limited life of such dampers. Through the use of chemical oil additives, the wear behavior can be improved, though not stopped. It is necessary to monitor the wear state of the oil by regular sampling and obtaining an analysis of the oil from the damper manufacturer. As soon as the oil wear state exceeds a wear limit, the damper is replaced or supplied with new oil on-site. This involves opening and cleaning the damper, the exchange of bearing elements, as well as the re-assembly and replenishment with oil. The bigger the damper, the more costly and involved this process becomes. With large dampers of the kind used for ship drives, dismantling, transport and reinstallation involve high costs, which can be more than the value of the damper. In addition, the power plants have to be at standstill, as they cannot be operated without dampers. More critically, the damper does not provide any indication that it is not working properly.

Still another disadvantage of the tuned and viscous dampers is the additional rotary inertia that the system power has to manage. This has the effect of requiring more energy to accelerate the driven equipment to a desired speed and lowering resonances potentially into the operational range of the equipment. The Viscous Damper also generates a significant fly wheel effect that is undesirable.

In one non-limiting exemplary system, wellbore servicing and monitoring equipment having a wellbore servicing component such as a shaft that joins a transmission to a pump are examples of systems where viscous dampers are used. Pumps are used to deliver wellbore servicing fluid into a wellbore. In these cases, electric motors and/or internal combustion engines drive transmissions while output driveshafts associated with the transmission drive the associated pumps. While the driveshafts are exposed to the normally occurring forces associated with driving the rotationally resistive load, the pumps themselves may additionally feedback cyclic and/or intermittent forces to the shafts and/or transmissions. The additional forces combined with the normally occurring forces may reduce a service life of the shafts and/or the transmissions.

In view of the limitations of the existing technology, it is desirable for a torsional vibration control system to eliminate or minimize resonant frequency in a driveshaft.

### SUMMARY

In accordance with this disclosure, a system and method of reducing vibration in a rotating component is disclosed.

In one aspect, a method of reducing vibration in a rotatable component is provided. The method comprises:
a. providing a rotatable component;
b. disposing a rotatable measurement interface on the rotatable component;
c. rotating the rotatable component;
d. operating the rotatable measurement interface to measure a strain of the rotatable component; and
e. imparting a corrective torque to the rotatable component as a function of the measured strain.

In another aspect, a method of reducing vibration in a rotatable component is provided. The method comprises:
a. providing a rotatable shaft;
b. disposing a rotatable measurement interface on the rotatable shaft;
c. rotating the rotatable shaft;
d. operating the rotatable measurement interface to measure a strain on the rotatable shaft;
e. transmitting the measured strain to a control system component;
f. determining a corrective torque as a function of the measured strain; and
g. imparting the corrective torque to the rotatable shaft

In yet other aspects, an active torsion damper control system is disclosed. The active torsion damper control system comprises a rotatable component, a rotatable measurement interface, a torque management computer and a correction motor. The rotatable measurement interface is disposed on the rotatable component, the rotatable measurement interface having a measuring component configured to measure a strain of the rotatable component. The torque management computer being configured to determine a corrective torque as a function of the measured strain. The correction motor being configured to impart the corrective torque on the rotatable component.

### BRIEF DESCRIPTION OF THE DRAWINGS

FIG. 1 is a simplified schematic view of a wellbore servicing system according to an embodiment.

FIG. 2 is a partial oblique view of a pumping system of the wellbore servicing system of FIG. 1.

FIG. 3 is an oblique view of a portion of the active torsion damper system of the pumping system of FIG. 2.

FIG. 4 is an orthogonal top cutaway view of a correction motor taken along line 4-4 of FIG. 3.

FIG. 5 is an oblique view of a portion of the correction motor of FIGS. 3 and 4.

FIG. 6 is an oblique cross-sectional view of the correction motor of FIGS. 3-5.

FIG. 7 is an oblique view of a correction motor according to an alternative embodiment.

FIG. 8 is an oblique side view of the correction motor of FIG. 7.

FIG. 9 is an orthogonal top cross-sectional view of the correction motor of FIGS. 7 and 8 taken along line 8-8 of FIG. 8.

FIGS. 10-23 show test data associated with the pumping system and an active torsional damper system.

FIG. 24 shows a simplified schematic diagram of control architecture of an active torsional damper system.

### DETAILED DESCRIPTION

This application discloses systems and methods for monitoring and controlling the strain and/or torque of a rotating driveshaft. The limitations of conventional torsional dampers can be overcome using Active Vibration Control (AVC) Systems. AVC Systems consist of one or more actuators intelligently driven by an electronics unit connected to vibration and/or strain sensors attached to the system to measure the vibration that needs to be ameliorated. The actuators are driven at one or more frequencies that are coincident with the harmonics of the systems excitation frequencies that would otherwise potentially cause structural damage and/or equipment reliability issues.

AVC Systems overcome the shortcomings of viscous and tuned dampers and are a direct replacement for viscous and tuned dampers. AVC Systems control the excitations produced as the engine speed and transmission gear stage change automatically. AVC Systems only require the addition of a small amount of inertia to the drive shaft, and hence, do not provide a flywheel effect and do not significantly lower torsional resonant frequencies of the system (which itself can lead to new problems). AVC Systems can be used to completely cancel the resonance excitations, and hence, high cycle fatigue never becomes an issue. The technology can easily replace conventional viscous and tuned dampers with minimal changes or no changes to the driveshaft components. As a result, the technology improves efficiency, reliability, and safety in power transmission systems.

The present invention recognizes that potentially damaging resonant torsional vibrations in a torque transmitting member can be controlled by the application of relatively small torsional impulses with synchronous application of a controlling torque along the driveshaft. Unlike passive control techniques previously discussed, this device is placeable anywhere along the driveshaft. The torsional resonant motion may be measured at numerous locations along the driveshaft, and may also be measured on bearing housings or gearbox. Preferably at least one sensor is used with this invention. More preferably, a plurality of sensors are used with this invention since sensors are generally inexpensive and provide for redundancy of data to the controller.

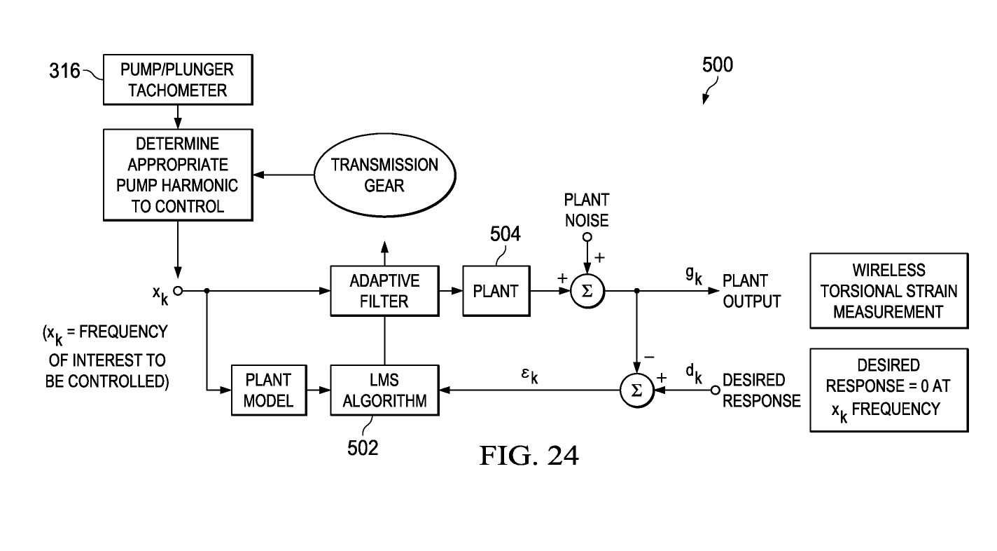

None of the prior art uses a feedforward controls approach whereby the controls can be directly synchronized from a tachometer or hall effect pick-up as is typically done for AVC applications. An example embodiment of the feedforward is shown in FIG. 24. The feedback sensor can be a wireless strain sensor affixed to the driveshaft, or could be a strain or vibration sensor affixed to a stationary housing of a component (like a gear box) that also vibrates due to the torsional resonance excitation. Additionally, the feedforward sensor for the example is a speed or tachometer sensor that measures the input excitation that could be a multiple of the drive shaft. The feedforward sensor may also be affixed to another part of the system whereby the excitation is not synchronous with the shaft revolutions per minute (RPM).

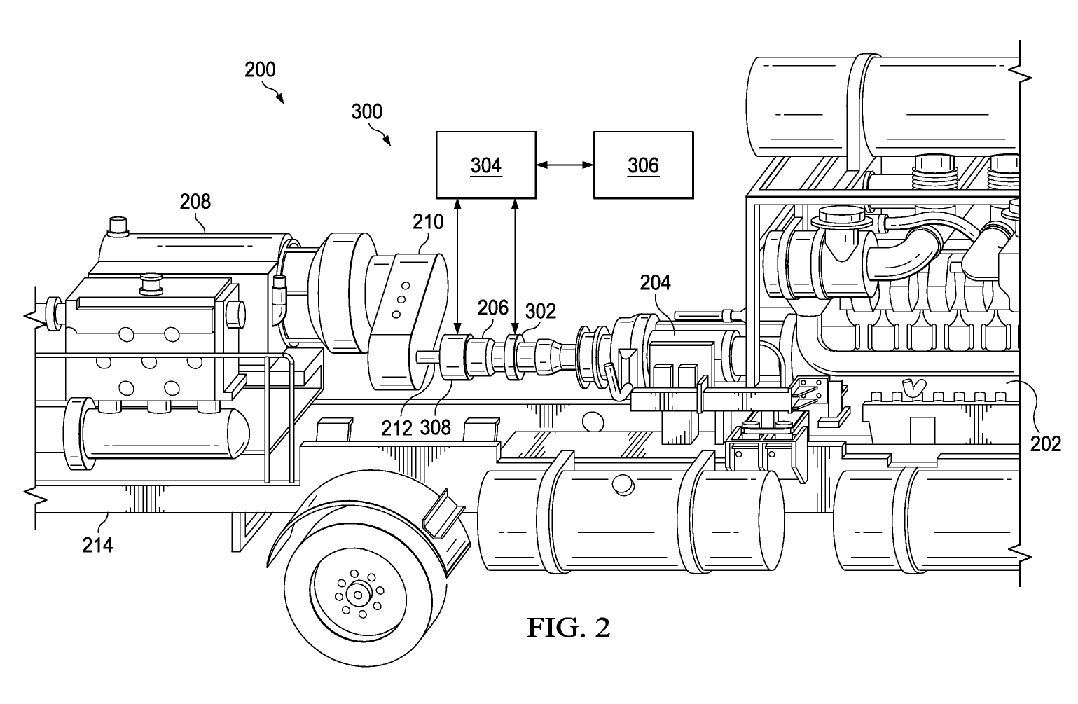

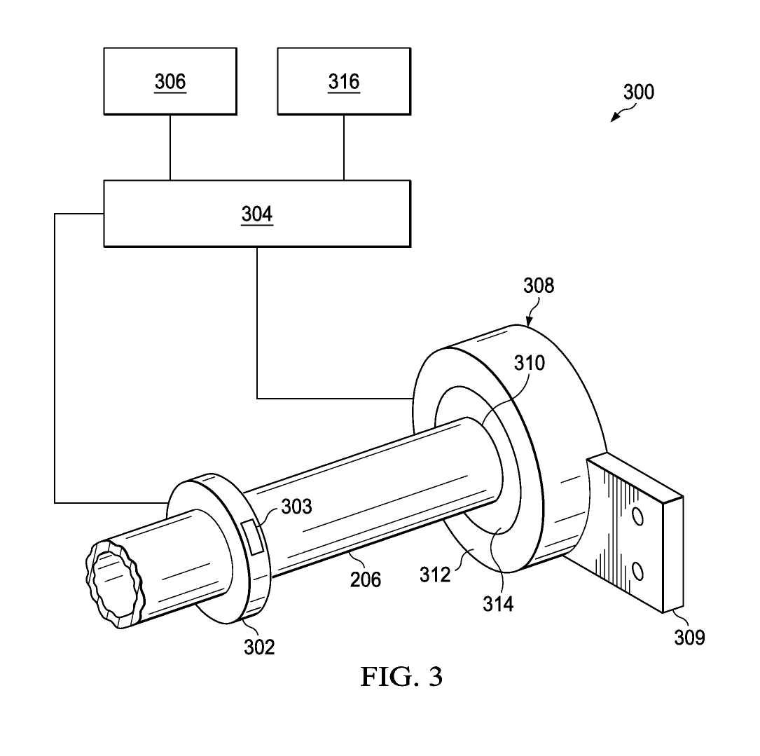

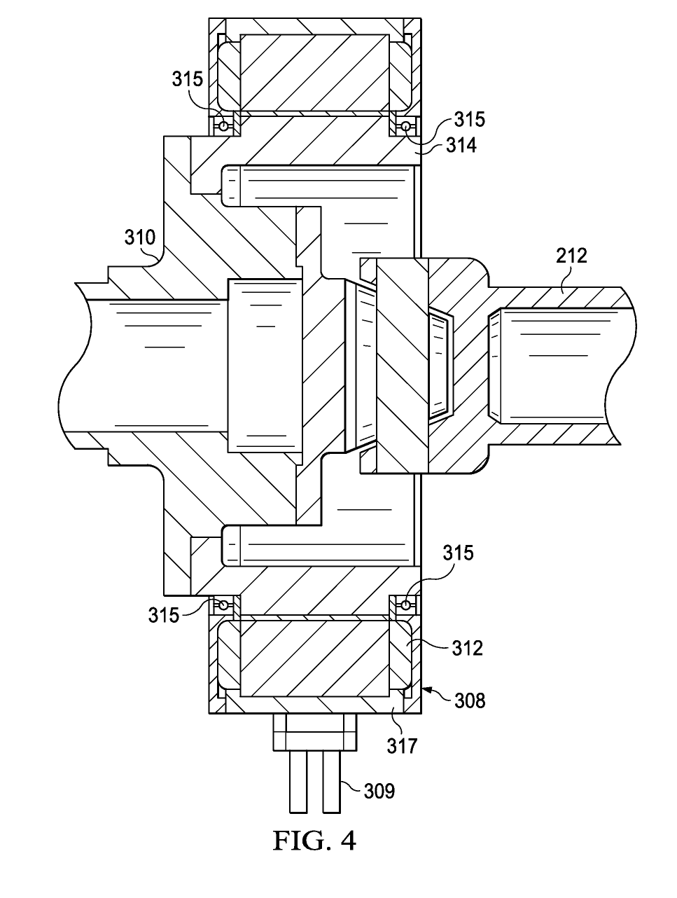

Referring to FIGS. 2-4, an embodiment using a stationary motor (fixed to the vehicle chassis) that encompasses the driveshaft (usually with a bearing that allows free rotation of the flange underneath the motor). In this embodiment, the flange attached to the drive shaft has little impact on the rotor inertia of the system. The illustrated embodiment does integrate light weight magnets on the shaft or flange attached to the shaft as shown in FIGS. 3 and 4, and has little to no impact on the driveshaft or drivetrain resonance frequency.

Referring now to a non-limiting exemplary system of a wellbore servicing component, the wellbore servicing component is used to illustrate the inventive system. In the wellbore servicing component a driveshaft (referred to hereinafter as a “shaft”) joins a transmission to a pump. In some wellbore servicing systems, the operation of a pump may generate cyclic and/or intermittent forces and/or vibrations that feed back to the shaft and/or transmission so that the shaft and/or transmission not only experience the normally anticipated forces of driving resistive rotation loads but also cyclic and/or intermittent variations in rotational loading attributable to the configuration of the one or more plungers of the pumps. The systems and methods disclosed herein monitor the forces applied to the shafts and/or the transmissions in a manner configured to allow application of corrective forces and/or mitigating forces to the shafts and/or transmissions. Accordingly, a wellbore servicing system 100 is disclosed below that may be operated according to a variety of methods and embodiments described herein.

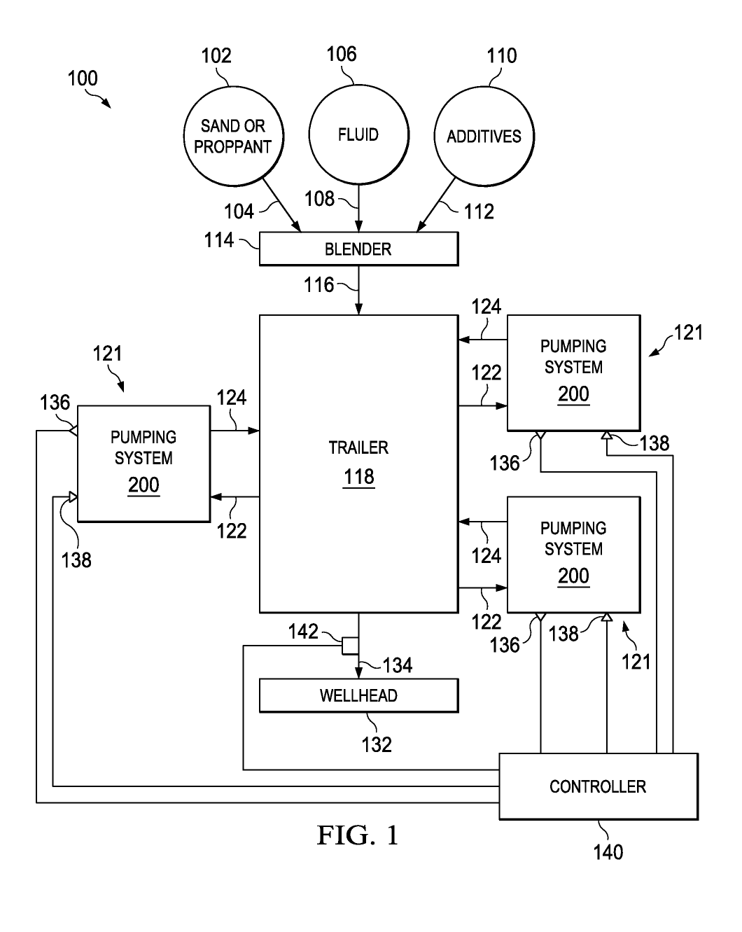

Referring to FIG. 1, a wellbore servicing system 100 is shown. The wellbore servicing system 100 may be configured for fracturing wells in low-permeability reservoirs, among other wellbore servicing jobs. In fracturing operations, wellbore servicing fluids, such as particle laden fluids, are pumped at high pressure downhole into a wellbore. In this embodiment, the wellbore servicing system 100 introduces particle laden fluids into a portion of a subterranean hydrocarbon formation at a sufficient pressure and velocity to cut a casing, create perforation tunnels, and/or form and extend fractures within the subterranean hydrocarbon formation. Proppants, such as grains of sand, are mixed with the wellbore servicing fluid to keep the fractures open so that hydrocarbons may be produced from the subterranean hydrocarbon formation and flow into the wellbore. Hydraulic fracturing creates high-conductivity fluid communication between the wellbore and the subterranean hydrocarbon formation.

The wellbore servicing system 100 comprises a blender 114 that is coupled to a wellbore services manifold trailer 118 via a flowline 116 and/or a plurality of flowlines 116. As used herein, the term “wellbore services manifold trailer” is meant to collectively comprise a truck and/or trailer comprising one or more manifolds for receiving, organizing, and/or distributing wellbore servicing fluids during wellbore servicing operations. In this embodiment, the wellbore services manifold trailer 118 is coupled via outlet flowlines 122 and inlet flowlines 124 to three pumping systems 200, such as the pumping system shown in FIG. 2 and discussed in more detail herein. Outlet flowlines 122 supply fluid to the pumping systems 200 from the wellbore services manifold trailer 118. Inlet flowlines 124 supply fluid to the wellbore services manifold trailer 118 from the pumping systems 200. Together, the three pumping systems 200 form a pump group 121. In alternative embodiments, however, there may be more or fewer pumping systems 200 used in a wellbore servicing operation. The wellbore services manifold trailer 118 generally has manifold outlets from which wellbore servicing fluids flow to a wellhead 132 via one or more flowlines 134.

The blender 114 mixes solid and fluid components to achieve a well-blended wellbore servicing fluid. As depicted, sand or proppant 102, water or other carrier fluid 106, and additives 110 are fed into the blender 114 via feedlines 104, 108, and 112, respectively. The fluid 106 may be potable water, non-potable water, untreated, or treated water, hydrocarbon based or other fluids. The mixing conditions of the blender 114, including time period, agitation method, pressure, and temperature of the blender 114, may be chosen by one of ordinary skill in the art with the aid of this disclosure to produce a homogeneous blend having a desirable composition, density, and viscosity. In alternative embodiments, however, sand or proppant, water, and additives may be premixed and/or stored in a storage tank before entering the wellbore services manifold trailer 118.

The wellbore servicing system 100 further comprises sensors 136 associated with the pumping systems 200 to sense and/or report operational information about the pumping systems 200. The wellbore servicing system 100 further comprises pumping system control inputs 138 associated with the pumping systems 200 to allow selective variation of the operation of the pumping systems 200 and/or components of the pumping systems 200. In this embodiment, operational information about the pumping systems 200 is generally communicated to a main controller 140 by the sensors 136. Further, the pump system control inputs 138 are configured to receive signals, instructions, orders, states, and/or data sufficient to alter, vary, and/or maintain an operation of the pumping systems 200. The main controller 140, sensors 136, and pumping system control inputs 138 are configured so that each pumping system 200 and/or individual components of the pumping systems 200 may be independently monitored and are configured so that operations of each pumping system 200 and/or individual components of the pumping systems 200 may be independently altered, varied, and/or maintained. The wellbore servicing system 100 further comprises a combined pump output sensor 142. The combined pump output sensor 142 is shown as being associated with flowline 134 which carries a fluid flow that results from the combined pumping efforts of all three pumping systems 200. The combined pump output sensor 142 is configured to monitor and/or report combined pump effect operational characteristic values (defined and explained infra) to the main controller 140. Alternatively, the combined output can be obtained by summing the output from individual sensors 136.

Referring now to FIG. 2, each pumping system 200 comprises a power source 202 and a plurality of rotatable components such as a transmission 204, a shaft 206, and a pump 208. Most generally, the power source 202 drives the transmission 204, the transmission 204 drives the shaft 206, and the shaft 206 drives the pump 208. A pump gearbox 210 is connected between the shaft 206 and the pump 208 so that the shaft 206 drives the pump gearbox 210 and the pump gearbox drives the pump 208. The pump gearbox 210 comprises a gearbox connector 212 connected to and driven by the shaft 206. The power source 202 comprises a diesel fuel internal combustion engine and the pump 208 comprises a positive displacement pump. In alternative embodiments, the power source 202 may comprise an electrically powered motor. In alternative embodiments, the pump 208 may not be a positive displacement pump but rather may comprise any other suitable type of pump. In some embodiments, the positive displacement pumps may comprise three plungers and be referred to as a triplex pump. In other embodiments, the positive displacement pumps may be a quadruplex pump and comprise four plungers, a quintuplex pump and comprise five plungers, or the positive displacement pump may comprise any other suitable number of plungers. In some embodiments, the pump 208 may comprise multiple plungers that operate in phase with each other. For example, a pump 208 may comprise six plungers wherein a first set of plungers are in phase with each other, a second set of plungers that are in phase with each other but out of phase with the first set of plungers, and a third set of plungers that are in phase with each other but out of phase with the first set of plungers and the second set of plungers. In some cases, the number, size, and/or relative phase of the plungers of a positive displacement pump may contribute to cyclical and/or intermittent forces that are fed back to one or more of the transmission 204, shaft 206, and/or pump gearbox 210. In some cases, the forces fed back to the rotatable components such as the transmission 204, shaft 206, pump 208, and/or pump gearbox 210 may affect a service life of those components so that the service life of those components is affected to be different than if the transmission 204, shaft 206, pump 208, and/or pump gearbox 210 were to simply experience a constant and/or non-cyclical variation in rotational resistance. In this embodiment, the pumping system 200 comprises a hydraulic fracturing truck 214 configured to carry, support, and/or transport other portions and/or components of the pumping system 200. Further, each pumping system 200 further comprises an active torsion damper system 300.

Referring now to FIG. 3, the active torsion damper system 300 generally comprises a rotatable measurement interface 302, a data transceiver 304, a torsion management computer 306, and a correction motor 308. The system 300 further comprises a shaft interface 310 configured to connect the motor 308 to the shaft 206 so that the shaft interface 310 rotates within the correction motor 308 in unison with the shaft 206. The rotatable measurement interface 302 is connected to an exterior of the shaft 206. The rotatable measurement interface 302 comprises at least one torsional strain gauge 303 connected to the shaft 206. However, in some embodiments, the rotatable measurement device 302 comprises a plurality of torsional strain gauges 303. The rotatable measurement interface 302 is configured to supply any necessary power to the torsional strain gauges 303, receive and interpret signals from the torsional strain gauges 303, record strain information obtained from the torsional strain gauges 303, wirelessly transmit information about the operation of the rotatable measurement interface 302, and/or receive instructions regarding controlling the operation of the rotatable measurement interface 302. Using the signals from the torsional strain gauges 303, the rotatable measurement interface 302 calculates the amount of continuous rotational force and/or corrective torque from correction motor 308 necessary to counter the measured torsional strain.

The correction motor 308 is connected to at least one of the gearbox connector 212 and the shaft 206 so that the correction motor 308 can apply continuous rotational force and/or corrective torque to at least one of the gearbox connector 212 and the shaft 206. The correction motor 308 also includes a motor fixture 309 that is secured to a frame and/or chassis of a trailer and/or vehicle that carries the active torsion damper system 300 and/or the pumping system 200. The correction motor 308 and the rotatable measurement interface 302 are configured to communicate with the data transceiver 304, and the data transceiver 304 is configured to communicate with the torsion management computer 306.

In operation, the rotatable measurement interface 302 sends information about the strain of the shaft 206 obtained by the torsional strain gauges 303 to the torsion management computer 306 via the data transceiver 304. In some embodiments, the data transceiver 304 is coupled to a speed sensor 316 and also communicates speed information about the shaft 206 obtained by the speed sensor 316 to the torsion management computer 306. The torsion management computer 306 utilizes the strain information, and in some embodiments the speed information, to generate a control command comprising an amplitude and a frequency and/or signal that is sent to the correction motor 308 via the data transceiver 304. Most generally, the control command and/or signal is selected so that when the correction motor 308 receives the control command and/or signal, the correction motor 308 may apply a continuous rotational force and/or corrective torque to the shaft 206 to reduce the amplitude of a vibration, torsion, and/or excitation on the shaft 206. The correction motor 308 can apply corrective torque in both directions of rotation of the shaft 206 and in amplitudes selected by the torsional management computer 306 in response to the strain measurements measured by the torsional strain gauges 303 and communicated to the torsional management computer 306 by the data transceiver 304 to reduce a maximum torsion, reduce resonant and/or cyclical torsional vibration related strains, and/or to mitigate spurious torsion strain peaks. It will further be appreciated that the active torsion damper system 300 comprises a feed-forward control architecture and the continuous rotational force and/or corrective torque applied by the correction motor 308 to the shaft 206 may continuously change in amplitude and/or frequency as the strain on the shaft 206 as measured by the torsional strain gauges 303 changes, a transmission gear changes, and/or a rotational speed of the shaft 206 changes. Accordingly, the torsion management computer 306 may continuously receive strain data and adjust the force applied by the correction motor 308 to compensate for real-time changes in the performance of the shaft 206.

Referring to the hydraulic fracturing truck 214 example above, the corrective torque applied is opposite of the measured torsional strain and opposes the dynamic strain at the frequency of interest. In this exemplary embodiment, the frequency of interest is determined using a measurement of a pump crank speed (which can be determined from the transmission tachometer and the appropriate gear or drive shaft speed), multiplied by the number of pistons in the pump, or a harmonic thereof. The system can control a multitude of harmonics if desired.

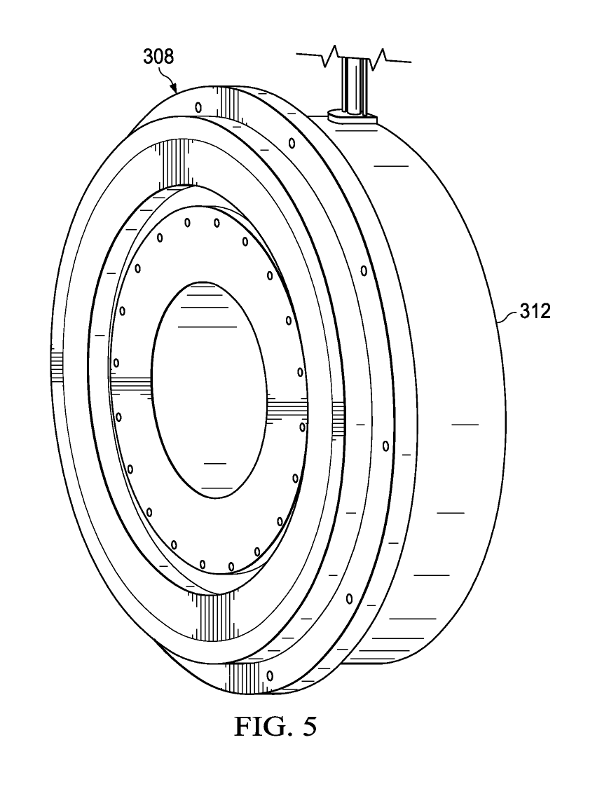

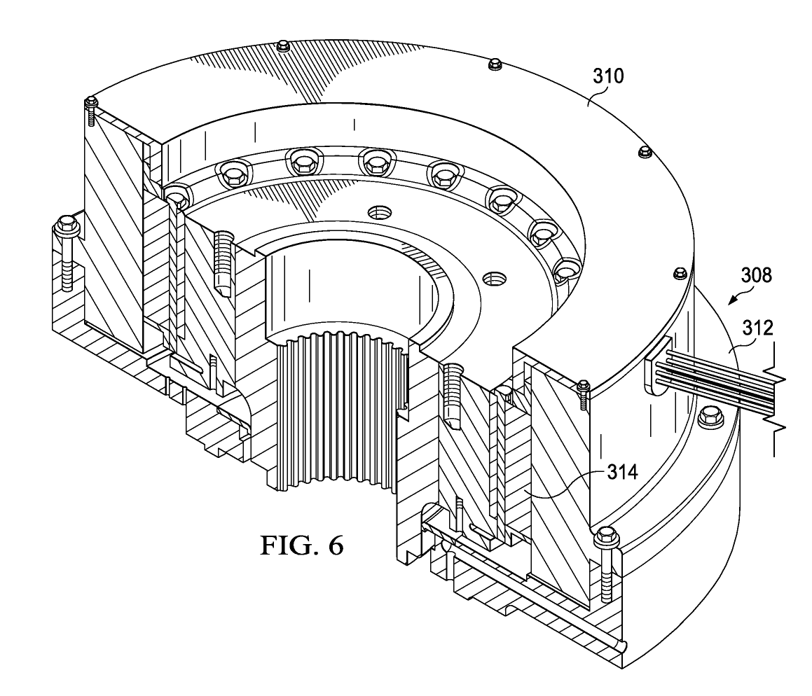

Referring now to FIGS. 4-6, the correction motor 308 is shown in greater detail. FIG. 4 shows an orthogonal top cutaway view of the correction motor 308, FIG. 5 shows an oblique view of a portion of the correction motor 308, and FIG. 6 shows an oblique cross-sectional view of the correction motor 308. The correction motor 308 comprises an electromagnetic motor having stator components 312 and rotor components 314. The stator components 312 remain stationary within the correction motor 308 and are carried by a motor housing 317 that is fixed with respect to the shaft 206 by the motor fixture 309 and does not rotate with the shaft 206. In this embodiment, the rotor components 314 are carried by and/or connected to the shaft interface 310 and rotate with the shaft 206. In some embodiments, the rotor components 314 are affixed to and carried by the shaft 206. The correction motor 308 also comprises a plurality of bearings 315 disposed between the rotor components 314 and a stationary component of the correction motor 308 such as the stator components 312 and/or the motor housing 317. In operation, an electric current may be passed through the stator components 312, thereby applying an electromagnetic force on the rotor components 314 that in turn impart a rotational force and/or corrective torque to the shaft interface 310 and/or the shaft 206. As previously stated, the continuous rotational force and/or corrective torque to the shaft 206 functions to reduce the amplitude of a vibration, torsion, and/or excitation on the shaft 206.

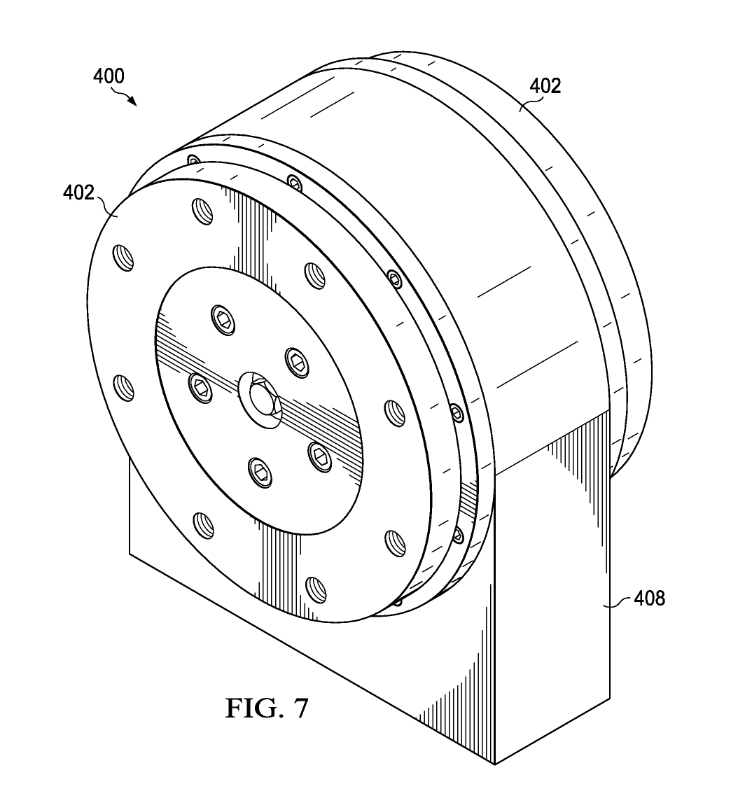

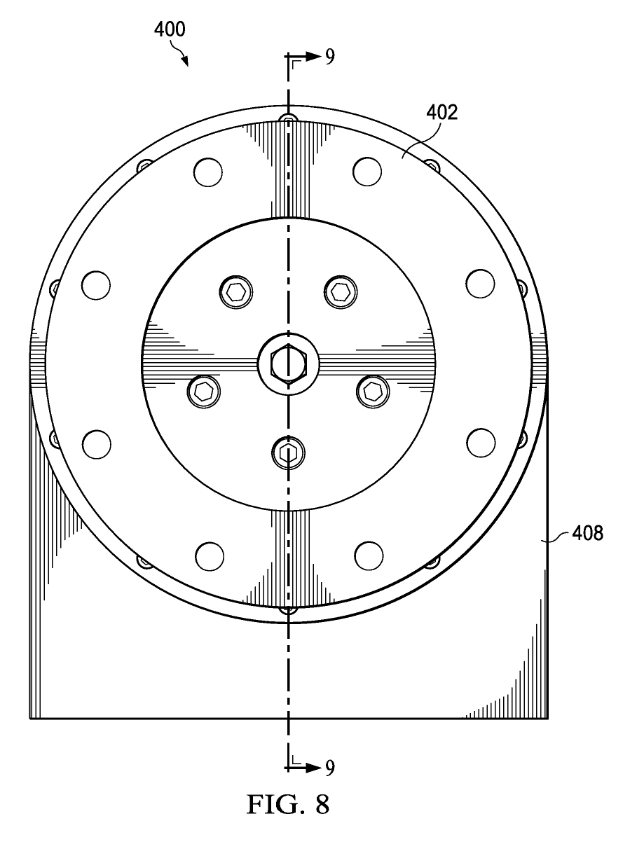

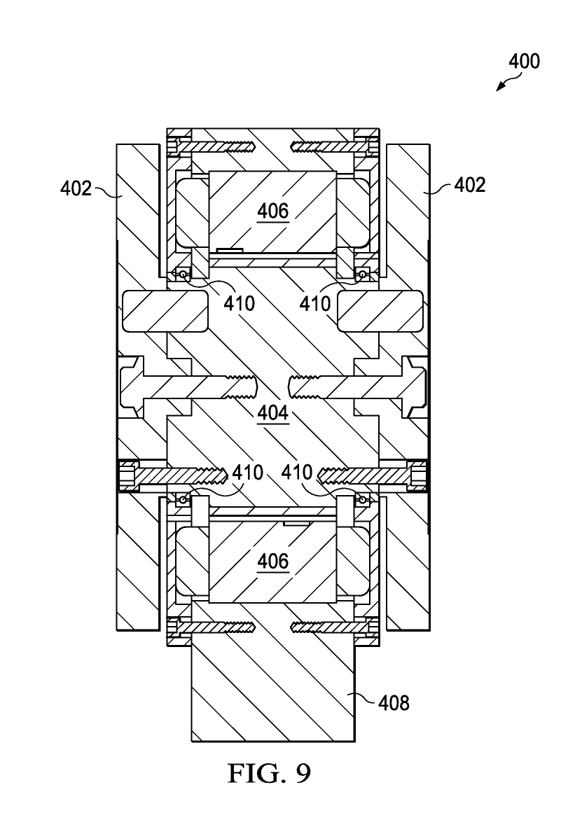

Referring now to FIGS. 7-9, an alternative embodiment of a correction motor 400 for an active torsion damper system is shown. FIG. 7 shows an oblique view of a correction motor, FIG. 8 shows an oblique side view of the correction motor 400 of FIG. 7, and FIG. 9 shows an orthogonal top cross-sectional view of the correction motor 400 of FIGS. 7 and 8 taken along the cutting line of FIG. 8. Correction motor 400 may be substantially similar to correction motor 308 and suitable for use in active torsion damper system 300. However, correction motor 400 comprises two shaft interfaces 402 that are joined to rotor components 404 and configured for connection between two shaft components (for example, by bisecting and/or dividing shaft 206 into two shaft components and disposing the correction motor 400 between the two shaft components). The correction motor 400 also comprises stator components 406, a motor housing 408, and a plurality of bearings 410. Similarly to the motor housing 317 of correction motor 308, the motor housing 408 of correction motor 400 is fixed to chassis and/or frame and does not rotate with the rotor components 404 and/or the shafts that the shaft interfaces 402 are connected to. In operation, an electric current may be passed through the stator components 406, thereby applying an electromagnetic force on the rotor components 404 that in turn impart a rotational force and/or corrective torque to the shaft interfaces 402 and/or the shaft components connected thereto. Similarly to correction motor 308, the continuous rotational force and/or corrective torque applied to the shaft components functions to reduce the amplitude of a vibration, torsion, and/or excitation on at least one of the shaft components.

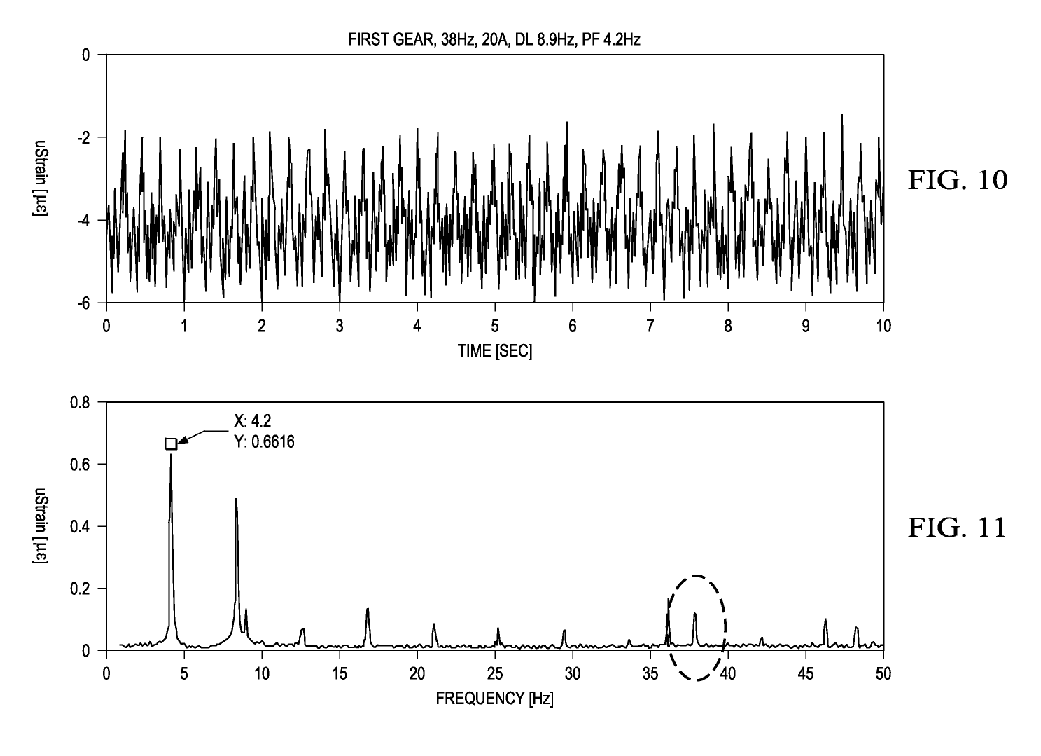

FIGS. 10-11 show test data received when operating a pumping system 200 operating with the transmission in a first gear. Although the pumping system 200 is outfitted with an active torsion damper system 300, the data of FIGS. 10-11 was obtained while the system 300 was inactive but for the indicated time and for the indicated strain response.

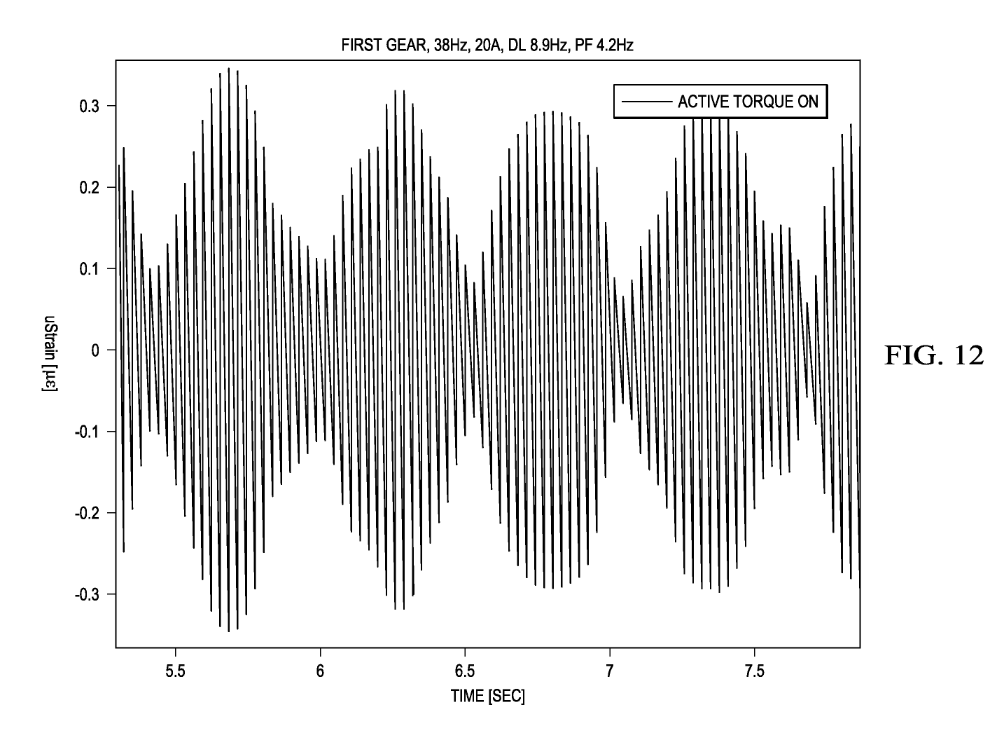

FIG. 12 shows test data received when operating the pumping system 200 of FIGS. 10-11 in the first gear but with the active torsion damper system 300 enabled and active to reduce strain by applying −21%, +28%, from the mean, 30 Newton meters (N·m) (rms) which is associated with an implied corrective torque requirement of about 5×30 N·m (rms)=210 N·m (peak). FIG. 12 is used to determine the force needed by the active torsion damper system 300 to excite a particular resonant frequency sought to be reduced and/or eliminated.

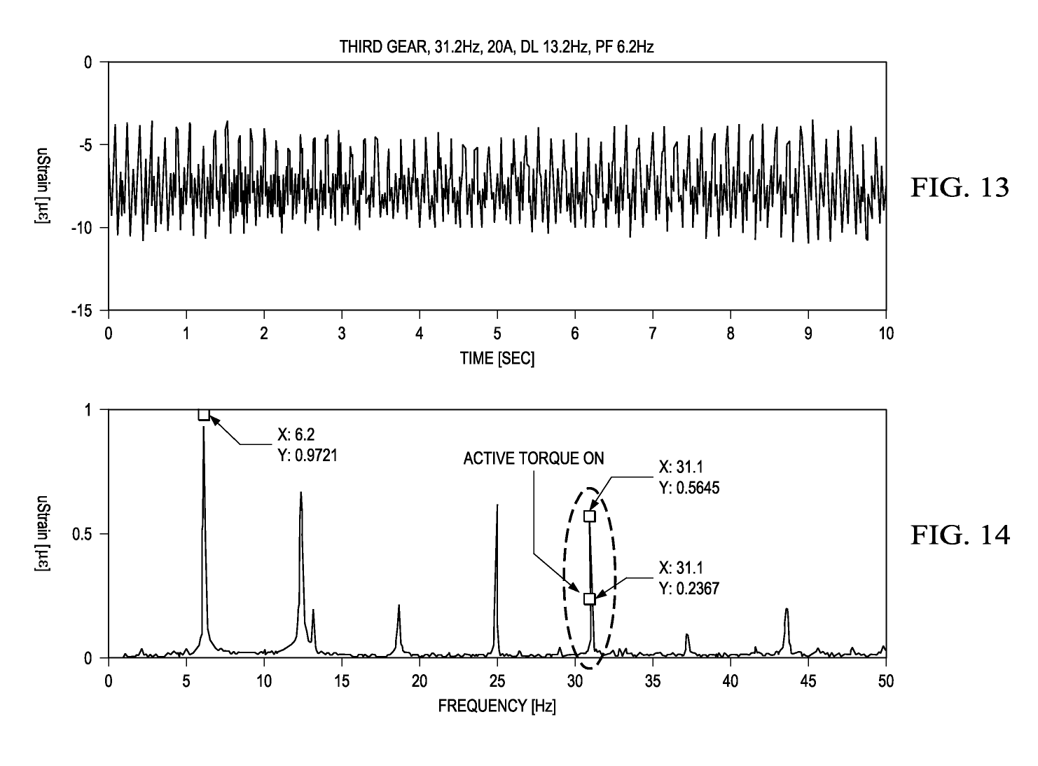

FIGS. 13-14 show test data received when operating a pumping system 200 operating with the transmission in a third gear. Although the pumping system 200 is outfitted with an active torsion damper system 300, the data of FIGS. 13-14 was obtained while the system 300 was inactive but for the indicated time and for the indicated strain response.

FIG. 15 shows test data received when operating the pumping system 200 of FIGS. 13-14 in the third gear but with the active torsion damper system 300 enabled and active to reduce strain by applying −58%, +53%, from the mean, 30 N·m (rms) which is associated with an implied corrective torque requirement of about 2×30 N·m (rms)=85 N·m (peak). FIG. 15 is used to determine the force needed by the active torsion damper system 300 to excite a particular resonant frequency sought to be reduced and/or eliminated.

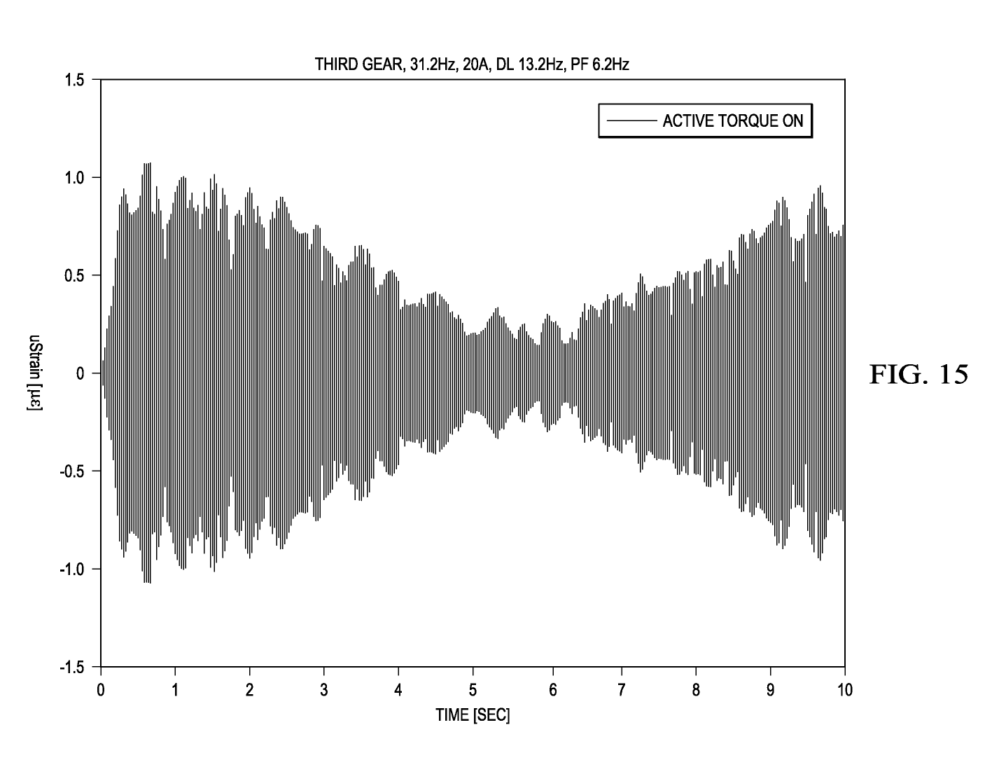

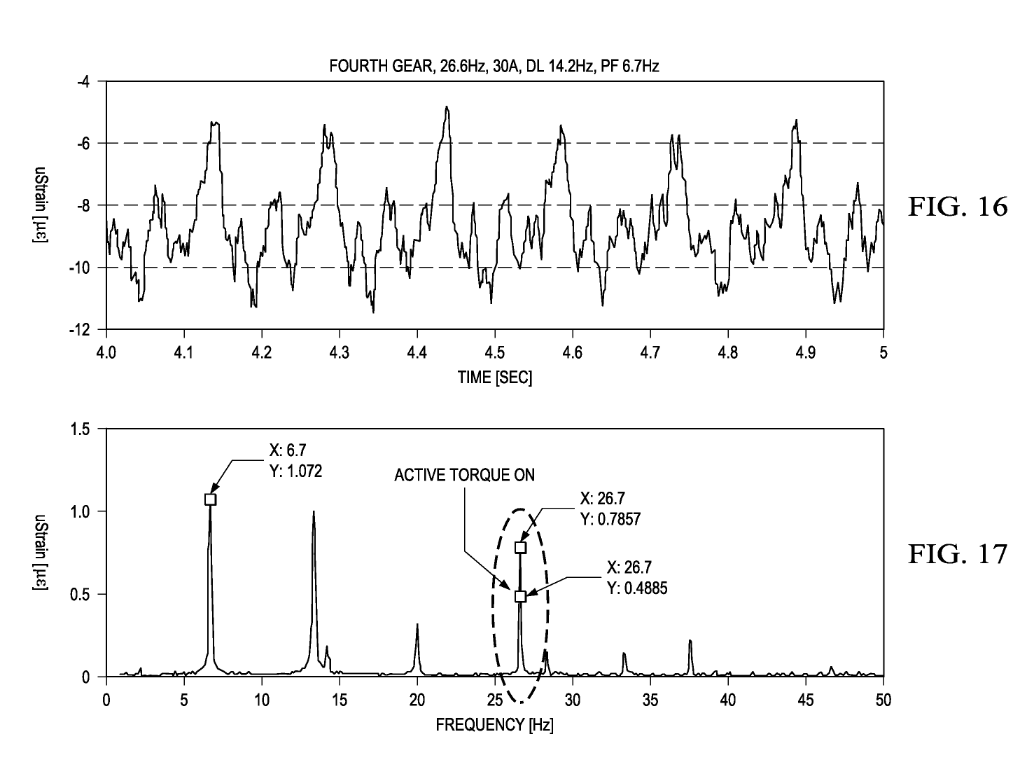

FIGS. 16-17 show test data received when operating a pumping system 200 operating with the transmission in a fourth gear. Although the pumping system 200 is outfitted with an active torsion damper system 300, the data of FIGS. 16-17 was obtained while the system 300 was inactive but for the indicated time and for the indicated strain response.

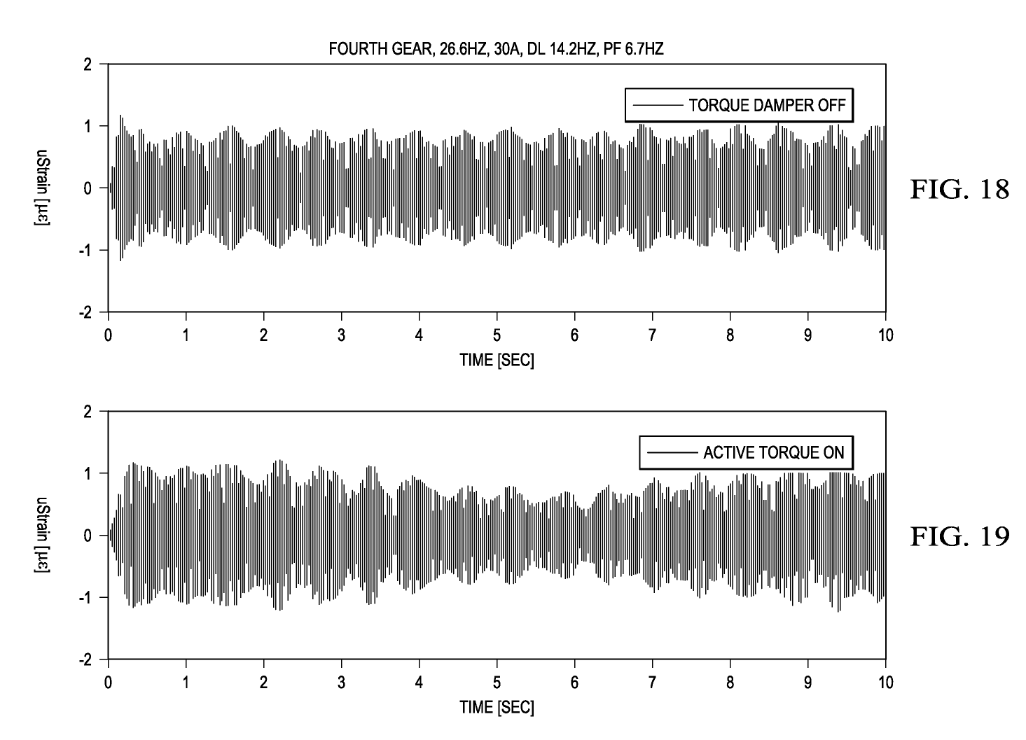

FIGS. 18-19 show ten seconds worth of microstrain data with FIG. 18 comprising data collected while the active torsion damper system 300 was inactive and with FIG. 19 comprising data collected while the active torsion damper system 300 was active, thus reducing strain −38%, +27%, from the mean 44 N·m (rms) which is associated with an implied corrective torque requirement of about 3×44 N·m (rms)=190 N·m (peak).

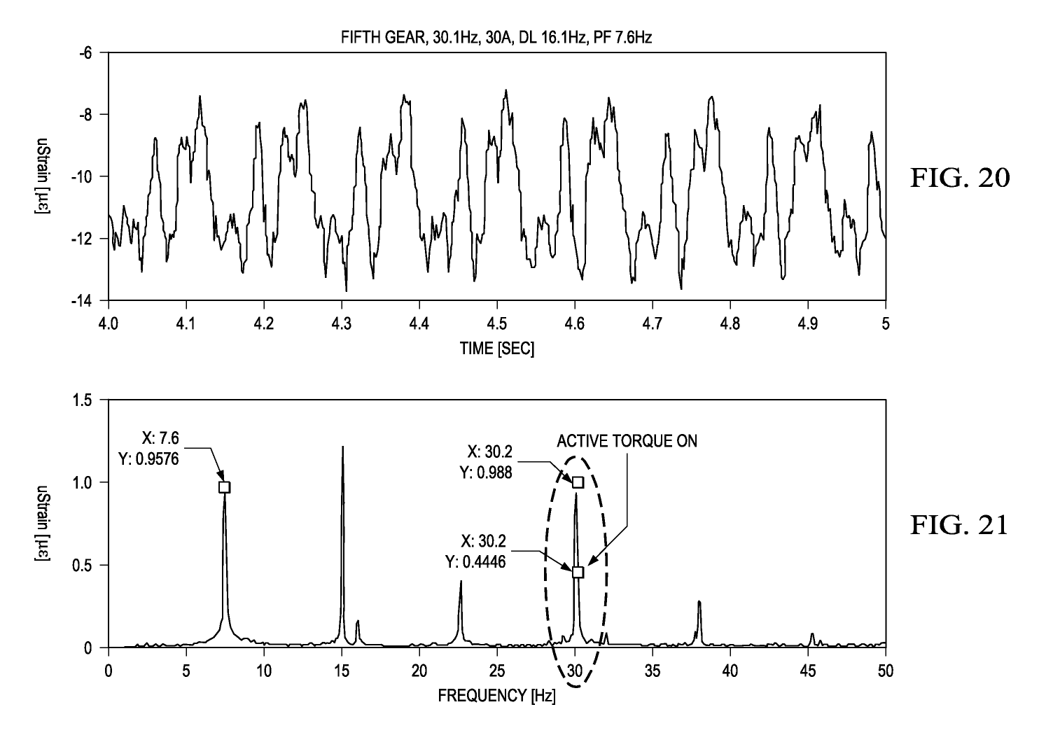

FIGS. 20-21 show test data received when operating a pumping system 200 operating with the transmission in a fifth gear. Although the pumping system 200 is outfitted with an active torsion damper system 300, the data of FIGS. 20-21 was obtained while the system 300 was inactive but for the indicated time and for the indicated strain response.

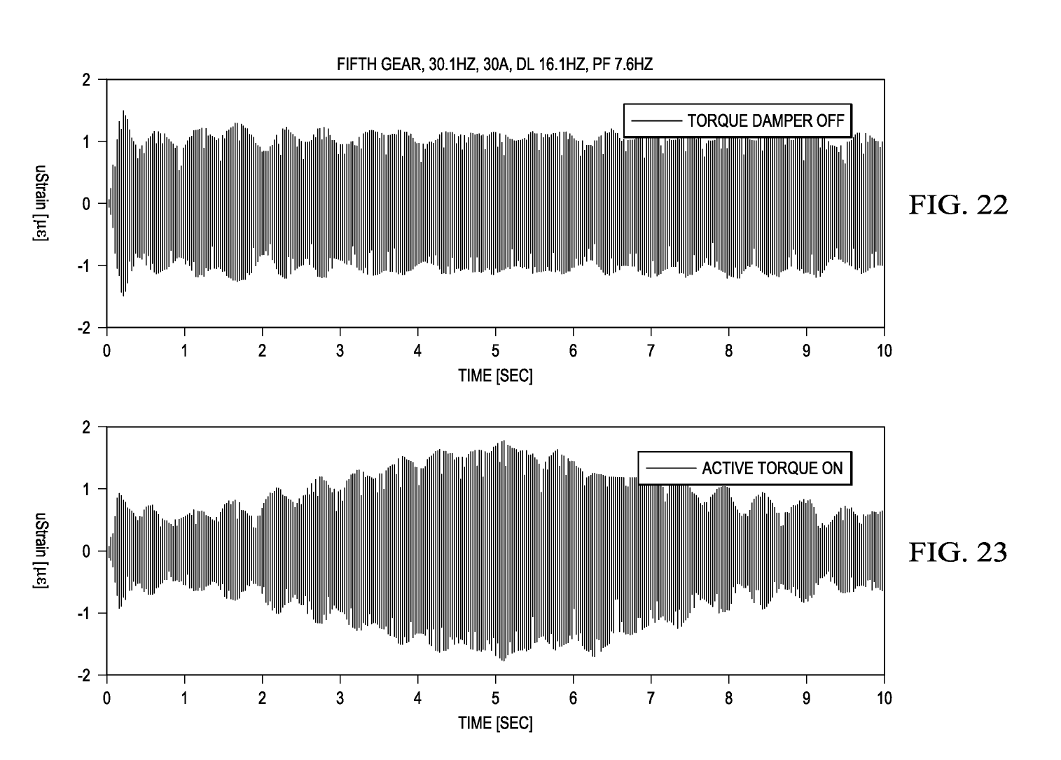

FIGS. 22-23 show ten seconds worth of microstrain data with FIG. 22 comprising data collected while the active torsion damper system 300 was inactive and with FIG. 23 comprising data collected while the active torsion damper system 300 was active, thus reducing strain −55%, +46%, from the mean 44N·m (rms) which is associated with an implied corrective torque requirement of about 2×44 N·m (rms)=120 N·m (peak).

FIG. 24 shows a simplified schematic representation of a control architecture 500 for an active torsion damper system 300. It will be appreciated that he control architecture 500 comprises a feed-forward control system and may be employed by the data transceiver 304 and/or the torsion management computer 306 to continuously monitor and/or control the performance of a rotatable shaft, such as shaft 206, and/or a plurality of shafts. The control architecture 500 receives a rotational speed value from a speed sensor and/or tachometer such as speed sensor 316. The control architecture correlates and/or associates the received rotational speed value of the rotatable shaft to a frequency of interest (resonant frequency) needed to be mitigated in the shaft. The control architecture 500 also receives torsional strain data from at least one torsional strain gauge such as a torsional strain gauge 303. The control architecture correlates and/or associates the received torsional strain data of the rotatable shaft to a continuous rotational force and/or corrective torque needed to excite the frequency of interest (resonant frequency) in the shaft. In some embodiments, the control architecture 500 also receives a corresponding transmission gear value that a transmission of a pumping system 200 is operating in. The control architecture 500 utilizes a Least Mean Square (LMS) Algorithm 502 that uses the received rotational speed value to determine a frequency of interest (resonant frequency) to be controlled and further uses the received torsional strain data to determine the corrective torque needed to be applied by a correction motor 308, 400 to excite the resonant frequency. The control architecture 500 employs a plant 504 (denotes crank/driveshaft/couplings/transmission/gearbox complete system) that applies an electrical current to the correction motor 308, 400 to cause the correction motor 308, 400 to create a torsional dynamic response that comprises a particular amplitude (associated with measured torsional strain data) and frequency (associated with measured rotational speed) that is applied to a shaft at about 180 degrees out of phase with the resonant frequency of the rotating shaft to cause destructive interference, thus reducing and/or cancelling vibration in the rotating shaft. The active torsion damper system 300, when utilizing the control architecture 500, is configured to reduce torsional resonant vibration/excitation resulting in high-cycle fatigue of critical equipment and components of pumping system 200, thus increasing the life of transmissions, piping, and driveshafts. In some cases, the active torsion damper system 300, when utilizing control architecture 500, may apply greater than 200 N·m of peak torque continuously in frequency ranges from about 25-40 Hertz to mitigate damage due to harmonic excitation (such as third or fourth harmonics) of the pumping system 200 components. Of course, these torque values are specific to the system tested and the teachings disclosed herein may be more generally applied to other pumping systems 200 and/or any other systems comprising rotating components that may benefit from lowered and/or managed strains.

In a method of reducing vibration in a rotatable component, the method comprises providing a rotatable component. In some embodiments, the rotatable component is a shaft 206. The method includes disposing a rotatable measurement interface 302 on the rotatable component. The method includes rotating the rotatable component. The method includes operating the rotatable measurement interface to measure a strain of the rotatable component, and the method includes imparting a corrective torque to the rotatable component as a function of the measured strain. The method further comprises imparting the corrective torque to the rotatable component using an electro-mechanical device. In some embodiments, the electro-mechanical device is a correction motor 308, 400. The method further comprises coupling the rotatable component to the correction motor via a shaft interface 310, 402. The method further comprises transmitting the measured strain to a control system component. In some embodiments, the control system component is a data transceiver 304, wherein the measured strain is transmitted wirelessly to the data transceiver 304. In some embodiments, the control system component is a torque management computer 306. The method further comprises determining a resonant frequency of the rotatable component. The method further comprises determining the corrective torque needed to excite the resonant frequency in the rotatable component. In some embodiments, the method comprises determining the corrective torque needed to excite the resonant frequency in the rotatable component using a feedforward control architecture 500. In some embodiments, the rotatable component is a component of a pumping system 200. The method further comprises disposing the pumping system on a hydraulic fracturing truck 214.

In a method of reducing vibration in a rotatable component the method comprises providing a rotatable shaft 206. The method comprises disposing a rotatable measurement interface 302 on the rotatable shaft. The method comprises rotating the rotatable shaft. The method comprises operating the rotatable measurement interface to measure a strain on the rotatable shaft. The method comprises transmitting the measured strain to a control system component. The method comprises determining a corrective torque as a function of the measured strain, and the method comprises imparting the corrective torque to the rotatable shaft. The method further comprises imparting the corrective torque to the rotatable shaft using an electro-mechanical device. In some embodiments, the electro-mechanical device is a correction motor 308, 400. The method of claim further comprises coupling the rotatable shaft to the correction motor via a shaft interface 310, 402. The method further comprises transmitting the measured strain to a control system component. In some embodiments, the control system component is a data transceiver 304, wherein the measured strain is transmitted wirelessly to the data transceiver 304. In some embodiments, the control system component is a torque management computer 306. The method further comprises determining a resonant frequency of the rotatable shaft. The method further comprises determining the corrective torque needed to excite the resonant frequency in the rotatable shaft. In some embodiments, the method comprises determining the corrective torque needed to excite the resonant frequency in the rotatable shaft using a feedforward control architecture 500. The method further comprises utilizing a Least Mean Square (LMS) Algorithm 502 in the feedforward control architecture 500 to determine the resonant frequency and the corrective torque needed to be applied to the rotatable shaft by a correction motor to excite the resonant frequency. In some embodiments, the rotatable component is a component of a pumping system 200. The method further comprises disposing the pumping system on a hydraulic fracturing truck 214.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

What is claimed is:

1. A method of reducing vibration in a rotatable component, comprising:
providing a rotatable component;
disposing a rotatable measurement interface on the rotatable component;
rotating the rotatable component;
operating the rotatable measurement interface to measure a strain of the rotatable component; and
imparting a corrective torque to the rotatable component as a function of the measured strain.

2. The method of claim 1, wherein the rotatable component is a driveshaft.

3. The method of claim 1, wherein the rotatable measurement interface comprises at least one strain gauge.

4. The method of claim 1, imparting the corrective torque to the rotatable component using an electro-mechanical device.

5. The method of claim 4, wherein the electro-mechanical device is a correction motor.

6. The method of claim 5, further comprising: coupling the rotatable component to the correction motor via a shaft interface.

7. The method of claim 1, further comprising: transmitting the measured strain to a control system component.

8. The method of claim 7, wherein the control system component is a data transceiver, and wherein the measured strain is transmitted wirelessly.

9. The method of claim 7, wherein the control system component is a torque management computer.

10. The method of claim 9, further comprising: determining a resonant frequency of the rotatable component.

11. The method of claim 10, further comprising: determining the corrective torque needed to excite the resonant frequency in the rotatable component.

12. The method of claim 11, further comprising: determining the corrective torque needed to excite the resonant frequency in the rotatable component using a feedforward control architecture.

13. The method of claim 12, wherein the rotatable component is a component of a pumping system.

14. The method of claim 13, further comprising: disposing the pumping system on a hydraulic fracturing truck.

15. A method of reducing vibration in a rotatable component, comprising:
providing a rotatable shaft;
disposing a rotatable measurement interface on the rotatable shaft;
rotating the rotatable shaft;
operating the rotatable measurement interface to measure a strain on the rotatable shaft;
transmitting the measured strain to a control system component;
determining a corrective torque as a function of the measured strain; and
imparting the corrective torque to the rotatable shaft.

16. The method of claim 15, wherein the rotatable shaft is a driveshaft.

17. The method of claim 15, wherein the rotatable measurement interface comprises at least one strain gauge.

18. The method of claim 15, further comprising: imparting the corrective torque to the rotatable shaft using an electro-mechanical device.

19. The method of claim 18, wherein the electro-mechanical device is a correction motor.

20. The method of claim 18, further comprising: coupling the rotatable shaft to the correction motor via a shaft interface.

21. The method of claim 15, further comprising: transmitting the measured strain to a control system component.

22. The method of claim 21, wherein the control system component is a data transceiver, and wherein the measured strain is transmitted wirelessly.

23. The method of claim 21, wherein the control system component is a torque management computer.

24. The method of claim 23, further comprising: determining a resonant frequency of the rotatable shaft.

25. The method of claim 24, further comprising: determining the corrective torque needed to excite the resonant frequency in the rotatable shaft.

26. The method of claim 25, further comprising: determining the corrective torque needed to excite the resonant frequency in the rotatable shaft using a feedforward control architecture.

27. The method of claim 26, further comprising: utilizing a Least Mean Square (LMS) Algorithm in the feedforward control architecture to determine the resonant frequency and the corrective torque needed to be applied to the rotatable shaft by a correction motor to excite the resonant frequency.

28. The method of claim 27, wherein the rotatable shaft is a component of a pumping system.

29. The method of claim 28, further comprising: disposing the pumping system on a hydraulic fracturing truck.

30. An active torsion damper control system, comprising:
a rotatable component;
a rotatable measurement interface disposed on the rotatable component, the rotatable measurement interface having a measuring component configured to measure a strain of the rotatable component;
a torque management computer configured to determine a corrective torque as a function of the measured strain; and
a correction motor configured to impart the corrective torque on the rotatable component.

31. The system of claim 30, wherein the rotatable component is a shaft.

32. The system of claim 30, wherein the measuring component comprises at least one strain gauge.

33. The system of claim 30, wherein the rotatable component is coupled to the correction motor via a shaft interface.

34. The system of claim 30, wherein the measured strain is wirelessly transmitted to a data transceiver.

35. The system of claim 34, wherein the data transceiver is configured to communicate the measured strain to the torque management computer.

36. The system of claim 35, wherein the torque management computer is configured to determine a resonant frequency of the rotatable component.

37. The system of claim 36, wherein the torque management computer is configured to determine the corrective torque needed to excite the resonant frequency in the rotatable component.

38. The method of claim 37, wherein the torque management computer is configured to determine the corrective torque needed to excite the resonant frequency in the rotatable component using a feedforward control architecture.

39. The system of claim 38, wherein the torque management computer is configured to store data related to the performance of the rotatable shaft.

40. The system of claim 38, wherein the torque management computer is configured to utilize a Least Mean Square (LMS) Algorithm in the feedforward control architecture to determine the resonant frequency and the corrective torque needed to be applied to the rotatable component by the correction motor to excite the resonant frequency.

41. The system of claim 40, wherein the active torsion damper system is a component of a pumping system.

42. The system of claim 41, wherein the pumping system is disposed on a hydraulic fracturing truck.
